(19) United States
(12) Patent Application Publication
(10) Pub. No.: US 2020/0166739 A1
(43) Pub. Date: May 28, 2020

(54) Systems and Methods for Configurable Miniature Microscopy

(71) Applicant: The Regents of the University of California, Oakland, CA (US)

(72) Inventor: Daniel Aharoni, San Diego, CA (US)

(21) Appl. No.: 16/610,793

(22) PCT Filed: May 15, 2018
(86) PCT No.: PCT/US2018/032679

§ 371 Date: Nov. 4, 2019

Related U.S. Application Data
(60) Provisional application No. 62/506,178, filed on May 15, 2017.

(51) Int. Cl. G02B 21/16; G02B 21/00; G02B 21/24

(52) U.S. Cl. CPC G02B 21/16; G02B 21/241; G02B 21/0008

(57) ABSTRACT

A microscopy system is disclosed. The system includes an excitation module that is configured to filter and shape an excitation light and produce a corresponding excitation module output. The system further includes an objective module including at least one electrowetting lens and configured to focus and direct the excitation module output and produce a corresponding objective module output. Additionally, the system includes an electronic control configured to adjust a focus of the at least one electrowetting lens. The system further includes an emission module coupled to the excitation module and the objective module. The emission module is configured to focus the objective module output and produce a corresponding emission module output.

### CROSS-REFERENCES TO RELATED APPLICATIONS

The present application is based on, claim priority to, and incorporates herein by reference in its entirety U.S. Provisional Patent Application No. 62/506,178, filed on May 15, 2017, and entitled “System and Method for Configurable Miniature Microscopy.”

### STATEMENT REGARDING FEDERALLY SPONSORED RESEARCH

This invention was made with government support under U01 NS094286-01 awarded by the National Institutes of Health. The government has certain rights in the invention.

### BACKGROUND

Miniature epi-fluorescence microscopes have been known in the art for several years. There are multiple designs for miniature epi-fluorescence microscopes that exist, and each current design implementation relies upon at least one of the following features to achieve a balance of function and size required for epi-fluorescence microscopes: (1) fixed magnification, (2) fixed imaging depth, (3) manually adjustable imaging depth, (4) large system magnification (for adjustable imaging depth systems, generally the overall magnification of the system is required to be large (>5×) to allow for repeatable/stable manual adjustment of the imaging depth), (5) fixed field-of-view (FOV) size (generally limited to around 0.5 mm2), (6) support of a wide-field, (semi)collimated excitation optical path, Köhler illumination, (7) use of cable assemblies to transmit power and data (hindering flexibility in imaging applications), (8) reliance of GRadiant INdex (GRIN) objective lenses (lenses limited to 2 mm diameter or smaller, restricting the FOV, and have high chromatic aberration), and (9) single microscope configuration of optics and imaging (not user-customizable).

While the above feature, or combinations thereof, have allowed conventional epi-fluorescence microscopes to meet many needs, the designs are limited in their capabilities in excitation source type and shape, as well as lacking in configurability and remote focal adjustment.

Therefore, it would be desirable to have a system and method for miniature microscopy that has, in addition to modularity, extended imaging capabilities that address the issues outline above.

### BRIEF SUMMARY

The present disclosure relates to systems and methods for a miniature microscopy assembly. More particularly, the present disclosure provides systems and methods to improve the configurability, flexibility, and features of miniature microscopes.

In accordance with one aspect of the present disclosure, a microscopy system is described. The system includes an excitation module configured to filter and shape an excitation light and produce a corresponding excitation module output. The system further includes an objective module including at least one electrowetting lens and configured to focus and direct the excitation module output and produce a corresponding objective module output. Additionally, the system includes an electronic control configured to adjust a focus of the at least one electrowetting lens. Further, the system includes an emission module coupled to the excitation module and the objective module and configured to focus the objective module output and produce a corresponding emission module output.

In accordance with one aspect of the present disclosure, a microscopy system is described. The system includes an excitation module configured to filter and shape an excitation light and produce a corresponding excitation output. The system further includes an objective module configured to focus and direct the excitation output and produce a corresponding objective output. Additionally, the system includes an emission module coupled to the excitation module and the objective module and configured to focus the objective output and produce a corresponding emission output. Further, the system includes a data acquisition system configured to detect and transmit the emission output. At least one of the excitation module, objective module, emission module, and data acquisition system are configured to be disengaged from the microscopy system and replaced by replacement modules to adjust a functionality of the microscopy system.

In accordance with one aspect of the present disclosure, a method of microscope imaging is described. The method includes providing a microscope imaging plane. The method further includes selecting an excitation module, an objective module, and an emission module from a set of interchangeable excitation, objective, and emission modules. Additionally, the method includes coupling the excitation module to the emission module. The method further includes coupling the emission module to the objective module. The method also includes filtering and shaping an excitation light output via the excitation module. The method includes forming an image corresponding to the excitation light output, the image formed at the microscope imaging plane. The method further includes detecting and transmitting an emission module output via a data acquisition system.

In accordance with one aspect of the present disclosure, a modular microscopy system is described. The system includes an excitation module configured to filter and shape an excitation light and produce a corresponding excitation module output. The system also includes an objective module configured to focus and direct the excitation module output and produce a corresponding objective module output, the objective module comprising at least one non-mechanical focusing element, and the at least one non-mechanical focusing element configured for electronic focusing. The system further includes an emission module configured to focus the objective module output and produce a corresponding emission module output. The excitation module is coupled to the emission module and the emission module is coupled to the objective module.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1A is a front view of a microscopy assembly in accordance with the present disclosure.

FIG. 1B is a perspective view of the microscopy assembly of FIG. 1A.

FIG. 1C is a cross-sectional view of the microscopy assembly of FIG. 1A.

FIG. 2A is a front perspective view of an excitation module in accordance with the present disclosure.

FIG. 2B is a back perspective view the excitation module of FIG. 2A in accordance with the present disclosure.

FIG. 3A is a partial cross-section of an excitation module in accordance with the present disclosure.

FIG. 3B is a schematic illustration of the excitation module of FIG. 3A with a light ray trace in accordance with the present disclosure.

FIG. 4 illustrates another excitation module including multiple excitation light sources in accordance with the present disclosure.

FIG. 5A illustrates another excitation module including a single excitation light source in accordance with the present disclosure.

FIG. 5B shows another excitation module including a fiber bundle in accordance with the present disclosure.

FIG. 6A is a perspective view of an emission module in accordance with the present disclosure.

FIG. 6B is a cross-section of the emission module of FIG. 6A illustrating the components therein in accordance with the present disclosure.

FIG. 6C is a schematic illustration of the emission module of FIG. 6A with a light ray trace in accordance with the present disclosure.

FIG. 7A is a perspective view of an objective module in accordance with the present disclosure.

FIG. 7B is a cross-section of the objective module of FIG. 7A illustrating the components therein in accordance with the present disclosure.

FIG. 7C is a schematic illustration of the objective module of FIG. 7A with a light ray trace in accordance with the present disclosure.

FIG. 8A illustrates the components of a microscopy assembly with a light ray trace in accordance with the present disclosure.

FIG. 8B illustrates an emission light path of the microscopy assembly of FIG. 8A.

FIG. 8C illustrates an excitation light path of the microscopy assembly of FIG. 8A.

FIG. 9 is a schematic illustration of another microscopy assembly in accordance with the present disclosure.

FIG. 10 is a schematic illustration of another microscopy assembly in accordance with the present disclosure.

FIG. 11 shows a schematic illustration of another microscopy assembly in accordance with the present disclosure.

FIG. 12 is a schematic illustration of a microscopy assembly including a data acquisition module in accordance with the present disclosure.

FIG. 13 is an example data acquisition module block diagram in accordance with the present disclosure.

FIG. 14 is an example data acquisition module schematic in accordance with the present disclosure.

FIG. 15 is a flowchart diagramming a method of microscope imaging using a microscopy assembly in accordance with the present disclosure.

### DETAILED DESCRIPTION

As will be described, a miniature microscopy system in accordance with the present disclosure may be configured for use in a variety of applications, including, as a non-limiting example, the measurement of populations of neurons at single cell resolution in freely behaving animals. As will be described, the miniature microscopy system may be used with any of a variety of applications that require diversity in imaging capabilities, including the imaging of neuron and cell cultures in vitro.

In one configuration, the present disclosure implements a modular framework allowing the user to customize each microscope's imaging properties to match a wide range of imaging applications. This may be achieved by dividing the microscope into multiple independently functioning modules/components. In one non-limiting example, modules or components may include: 1) objective module, 2) excitation module, 3) emission module, 4) DAQ module, with each module having multiple implementations satisfying different imaging needs. A microscope may then be constructed by combining modules, with the user picking the specific implementation of each module that corresponds to the imaging application.

In accordance with some configurations, an objective module may include a focusing element that may determine or control an imaging depth of a modular microscopy system according to the present disclosure. For example, the focusing element may be a non-mechanical focusing element that is configured to non-mechanically adjust an imaging depth. In one implementation, the non-mechanical focusing element may be configured to electronically adjust an imaging depth. In some non-limiting examples, the focusing element may be an electronic focusing lens with optical x/y translation capabilities. This may be an electrowetting/liquid lens, and may remove the need for manual imaging depth adjustment while matching or exceeding the range of depth adjustment of previous miniature microscopes. Without the need for manual/mechanical imaging depth adjustment, the disclosed microscope system may have the option to operate at much lower magnifications (e.g. down to 2×). While still fully capable of higher magnifications, lower magnification may be a better match for certain imaging sensors and other optical detectors. In some non-limiting examples, an electrowetting lens that may also have the capability to electrically/remotely translate the field-of-view perpendicular to the optical imaging axis.

In accordance with another aspect of the disclosure, an excitation pathway is provided that may enable an image of the excitation light source to be formed at the same depth being imaged by the microscope. While still compatible with wide-field, Köhler illumination, this excitation pathway may be used with structured illumination, Digital Micromirror Devices (DMD), Spatial Light Modulators (SLM), and fiber bundles. The optical path may also be used with standard LEDs having a flat diffusor to form a plane of higher intensity excitation light that is coplanar with the imaging plane.

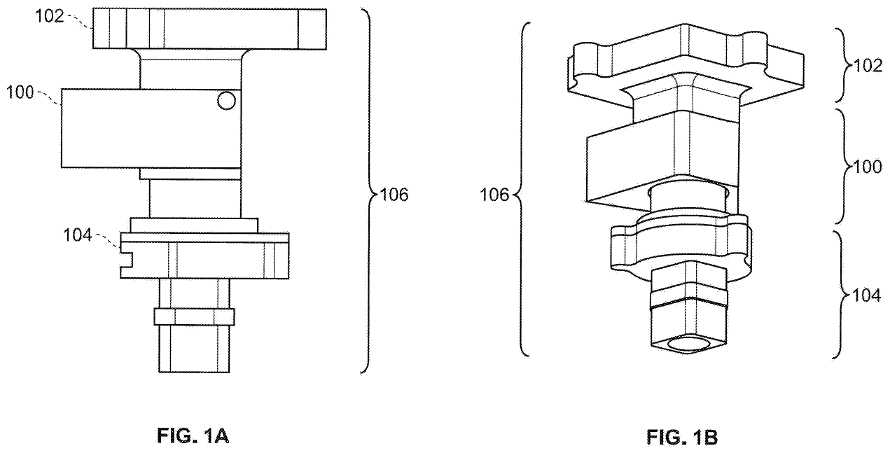

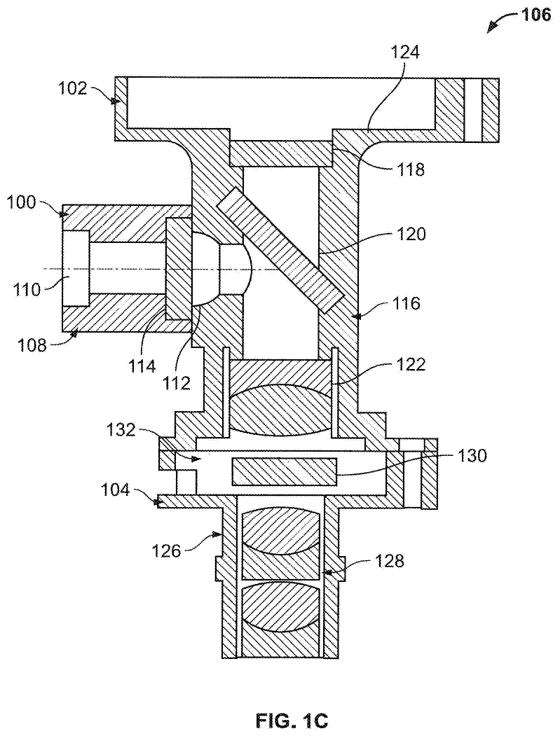

Referring to FIGS. 1A-1C, one non-limiting example of a microscopy assembly 106 is illustrated. The microscopy assembly 106 may include an excitation module 100, an emission module 102, and an objective module 104. In one non-limiting example, the microscopy assembly 106 may have a modular design. For example, the objective module 104, the excitation module 100, the emission module 102, and/or a DAQ module (not shown) may be configured to be removably coupled with one another to form the microscopy assembly 106. In some non-limiting examples, the objective module 104, the excitation module 100, the emission module 102, and/or the DAQ module (not shown) can be selectively removed from the microscopy assembly 106 and replaced (e.g., with another module having differing optical properties) based upon a desired imaging application or functionality.

In accordance with one aspect of the disclosure, the objective module 104, the excitation module 100, the emission module 102, and/or the DAQ module (not shown) may be removably coupled via screws. In accordance with another aspect of the disclosure, the objective module 104, the excitation module 100, the emission module 102, and/or the DAQ module (not shown) may be removably engaged via magnets. In accordance with another aspect of the disclosure, the objective module 104, the excitation module 100, the emission module 102, and/or the DAQ module (not shown) may be removably engaged via latching mechanisms (e.g., pins, quick-disconnects, keyed features, etc.).

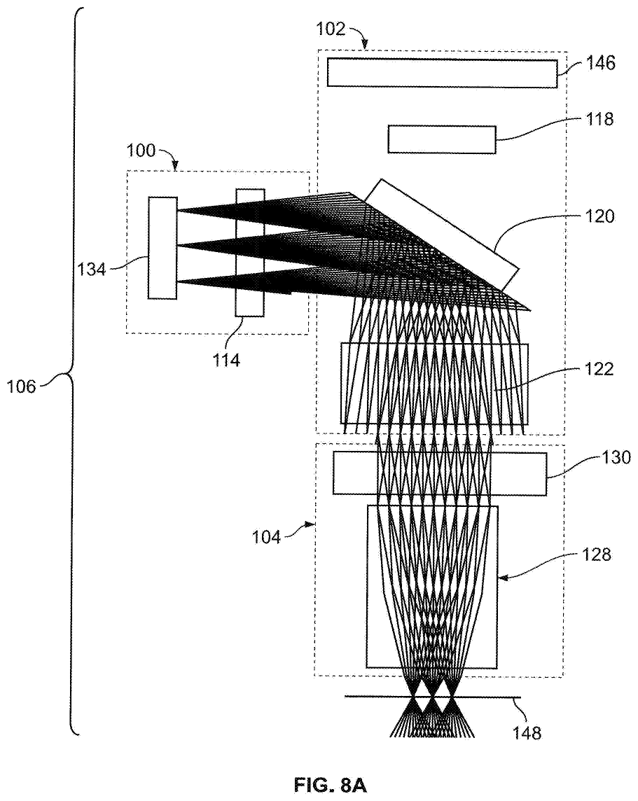

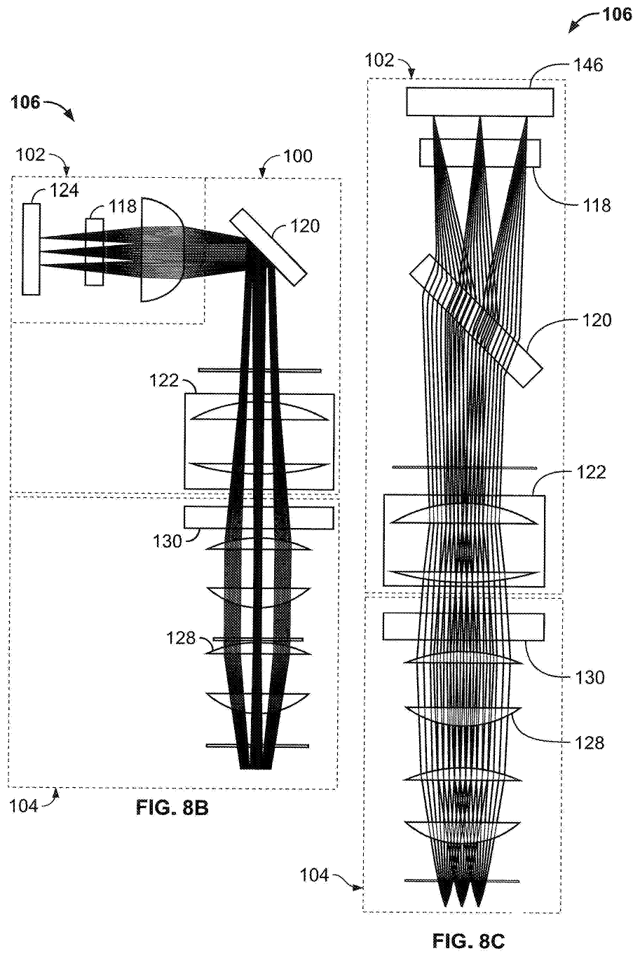

In the illustrated non-limiting example, the excitation module 100 may be removably coupled to the emission module 102. For example, the excitation module 100 may be removably coupled to a side of the excitation module 100, such that light emitted from the excitation module 100 transmits into the emission module 102 at an angle (e.g., perpendicularly to) an optical path defined along the emission module 102 (see, e.g., FIG. 8A). In the illustrated non-limiting example, the emission module 102 may be removably coupled to the objective module 104. For example, the emission module 102 may be removably coupled to the objective module 104, such that an optical path defined along the emission module 102 generally aligns (e.g., is arranged substantially parallel with) an optical path defined along the objective module 104 (see, e.g., FIG. 8A). The microscopy assembly 106 may be user-customizable via the selection of the emission module 102, the excitation module 100, and the objective module 104 from a plurality of modules. The plurality of modules may have different optical properties, thus enabling a user to select modules based on the desired imaging application.

With specific reference to FIG. 1C, the excitation module 100 may include an excitation housing 108 with an excitation source mount 110 formed therein that is configured to at least partially receive an excitation light source (not shown). The excitation source mount 110 may be configured to arrange the excitation light source to emit excitation light toward and through an input aperture 112 formed in a side of the emission module 102. In the illustrated non-limiting example, the input aperture 112 may be shaped to receive a shaping element (not shown) of the excitation module 100. The excitation module 100 may include an excitation filter 114 arranged between the excitation source mount 110 and the input aperture 112.

The emission module 102 may include an emission housing 116, an emission filter 118, a dichroic mirror 120, the input aperture 112, and a tube lens 122. In the illustrated non-limiting example, the emission filter 118 may be arranged within the emission housing 116 at one end thereof and the tube lens 122 may be arranged within the emission housing 116 at an opposing end thereof. The dichroic mirror 120 may be arranged between the emission filter 118 and the tube lens 122. The input aperture 112 is arranged in a side of the emission housing 116 to which the excitation module 100 is removably coupled. The input aperture 112 is configured to receive excitation light from the excitation light source (not shown). The dichroic mirror 120 may be configured to reflect the excitation light from the excitation light source toward the tube lens 122 and the objective module 104. The dichroic mirror 120 may also be configured to transmit image light (e.g., fluorescent light from an object being imaged) from an image plane and allow the image light to transmit toward an output mount 124 formed in the emission housing 116 for capturing by an image sensor or a photodetector.

The objective module 104 may include an objective housing 126, one or more objective lenses 128, and a focusing element 130. In the illustrated non-limiting example, the objective housing 126 includes a focusing element cavity 132 that defines a recessed cavity extending into one end of the objective housing 126. The focusing element 130 may be received, sealed, and/or enclosed within the focusing element cavity 132.

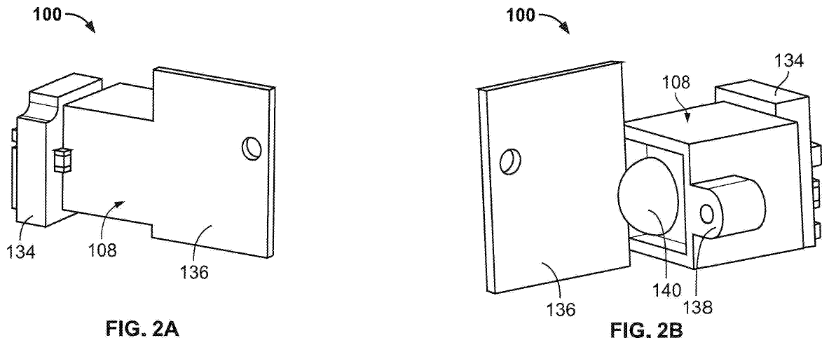

FIGS. 2A and 2B illustrate one non-limiting example the excitation module 100. In the general, the excitation module 100 includes the excitation housing 108 and one or more optical elements necessary for filtering, shaping, focusing, and/or defocusing excitation light emitted from an excitation light source 134. The one or more optical elements may be coupled to and/or arranged at least partially within the excitation housing 108 in a particular orientation to achieve a desired optical effect. The excitation light source 134 may be coupled to or arranged within the excitation source mount 110 of the excitation housing 108.

In the illustrated non-limiting example, the excitation housing 108 includes a mounting plate 136 extending from one side thereof and a mounting flange 138 extending from another side thereof. The mounting plate 136 and the mounting flange 138 each include an aperture extending therethrough, which facilitates the removable coupling to the emission module 102, for example, via a fastening element (e.g., a screw, bolt, etc.). The location of the attachment point on the excitation module 100 and the emission module 102 may be standardized, making the optical properties and function of the excitation modules independent from the optics of the rest of the microscope.

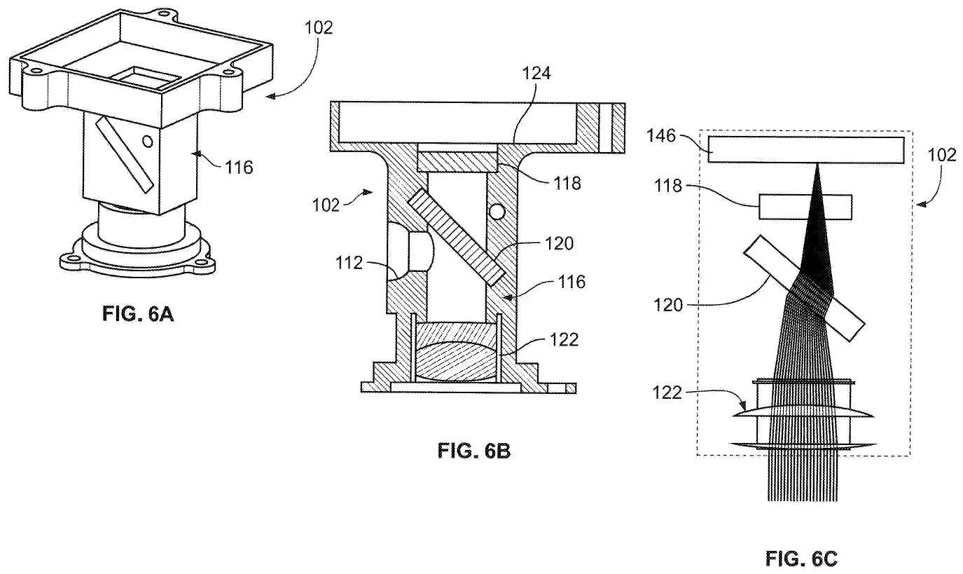

In some non-limiting examples, the excitation housing 108 may not include the mounting plate 136 and/or the mounting flange 138, and may be removably coupled to a side of the emission module 102 via magnets, or another removable latching mechanism. When the excitation module 100 is coupled to the side of the emission module 102, excitation light from the excitation light source 134 may be passed into the emission module 102 through the input aperture 112 (see, e.g., FIG. 6B).

In some non-limiting examples, the one or more optical elements of the excitation module 100 may include, but are not limited to, optical filters, bandpass filter(s), passive lens(es), dichroic mirror(s), and thin sheet diffusor(s). In some non-limiting examples, the excitation light source 134 may be in the form of an onboard light emitting diode (LED), or an LED array. In some non-limiting examples, the excitation light source 134 may be an optical fiber or a fiber bundle. In some non-limiting examples, the emission module 100 may include a shaping element 140 configured to shape, direct, focus, and/or defocus light emitted from the excitation light source 134. In the illustrated non-limiting example, the shaping element 306 is in the form of a half-ball lens. In some non-limiting examples, the half-ball lens may be configured to defocus excitation light emitted from the excitation light source 134 in the imaging plane.

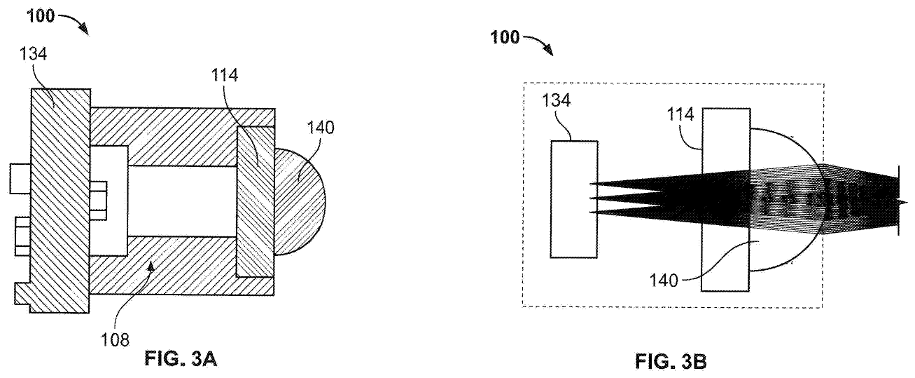

Turning to FIGS. 3A and 3B, the excitation light source 134 may be coupled to one end of the excitation housing 108 and the excitation filter 114 and the shaping element 140 may be coupled to another end of the excitation housing 108. In some non-limiting examples, the excitation filter 114 may be in the form of a bandpass filter. In the illustrated non-limiting example, the excitation filter 114 may be at least partially received within a recess formed in the excitation housing 108 and may be connected to the shaping element 140.

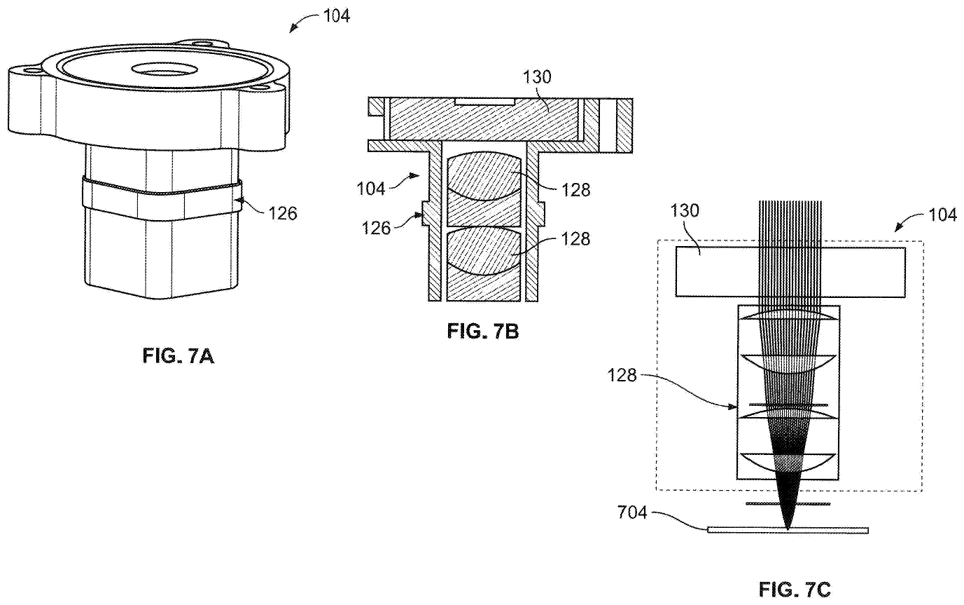

In certain situations, it may be beneficial to use a single excitation light source 134 to achieve Köhler illumination. FIGS. 2A-3B provide one non-limiting example of an excitation module 100 that includes a single excitation light source 134. For Köhler illumination, the excitation light source 134 may be focused on or near the back aperture of the objective module 104 so that the excitation light is semi or fully defocused in the imaging plane. Including the shaping element 140 (e.g., a single half-ball lens) in the excitation module 100, along with the tube lens 122 in the emission module 102 (see, e.g., FIGS. 7B and 7C) is one configuration capable of achieving Köhler illumination. In this non-limiting aspect, the excitation light source 134 may be an onboard LED or fiber mounted to the excitation module 100. The excitation light emitted by the excitation light source may be bandpass filtered by the excitation filter 114 before entering the emission module 102.

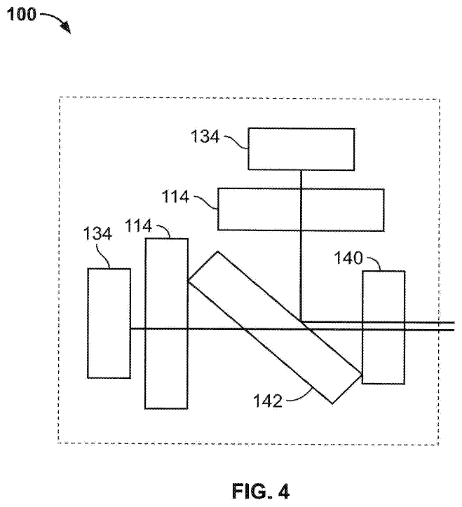

In certain situations, it may be beneficial to use a plurality of excitation light sources 134 to achieve Köhler illumination. FIG. 4 illustrates one non-limiting example of an excitation module 100 that includes a plurality of excitation light sources 134. This non-limiting excitation module 100 may function similarly to the module shown in FIGS. 2A-3B, but includes an additional excitation light source 134 and excitation filter 114. The excitation module 100 may also include a dichroic mirror 142 that is configured to transmit light from one of the excitation light sources 302 therethrough and reflect light from the other excitation light source 134. In this non-limiting example, each of the excitation light sources 134 may be arranged to achieve the same optical path distance to the shaping element 140. This may allow for exciting multiple fluorophores or opsins simultaneously or sequentially.

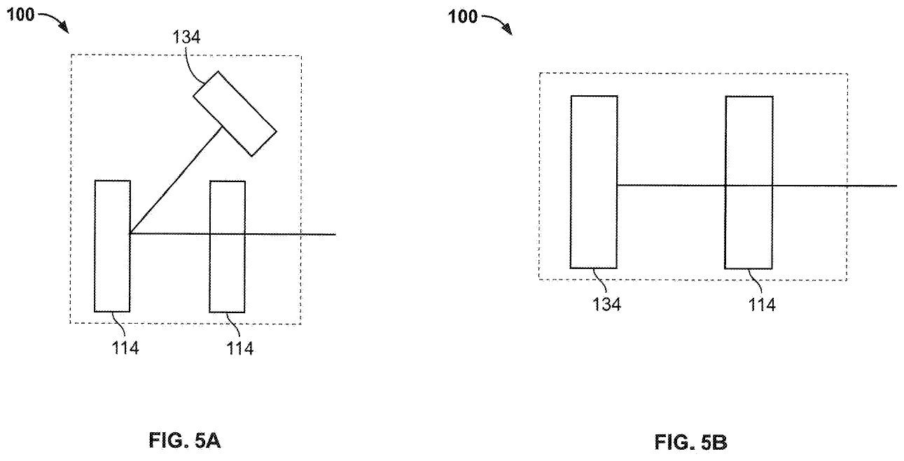

FIGS. 5A and 5B illustrate two additional non-limiting configurations of the excitation module 100. FIG. 5A illustrates the excitation module 100 including the excitation light source 134, a structured illumination surface 144, and the excitation filter 114. In some non-limiting examples, the structured illumination surface 144 may be in the form of a spatial light modulator (SLM) or a digital micromirror device (DMD). The excitation light source 134 may be arranged to emit excitation light toward the structured illumination surface 144 at an angle, and the structured illumination surface 144 may be configured to reflect the excitation light toward the excitation filter 114 and the emission module 102.

FIG. 5B illustrates one non-limiting example of the excitation module 100 where the excitation light source 134 may be in the form of a fiber bundle that is configured to emit light through the excitation filter 114. In the non-limiting examples of FIGS. 5A and 5B, the excitation module 100 may mount the excitation light source 134 at the same optical path distance (correcting for additional filter glass) away from the tube lens 122 within the emission module 102 as an imaging sensor or photodetector (see, e.g., FIG. 8A) arranged within the output mount 124. In other words, the imaging plane of the microscopy assembly 106 may be the same distance away from both the excitation light source 134 and the imaging sensor (see, e.g., FIG. 8A). This results in the optics of the emission module 102 and the objective module 104 forming an image of the surface of the excitation light source 134 co-planar with the imaging plane. These non-limiting examples of the excitation modules 100 may be implemented in the microscopy assembly 106 to achieve structured illumination microscopy.

FIGS. 6A-6C illustrate one non-limiting example of the emission module 102. In some non-limiting examples, the emission housing 116 of the emission module 102 may be the central housing to which the excitation module 100, objective module 104, and a DAQ module mount. The emission housing 116 of the emission module 102 may be a thin-walled housing that generally holds, but is not limited to, the tube lens 122, at least one dichroic mirror 120, and at least one emission filter 118. A top side (from the perspective of FIGS. 6A-6C) of the emission housing 116 may include the output mount 124, which defines a recessed cavity in the top side of the emission housing 116. In some non-limiting examples, the output mount 124 may be configured to receive or couple to an imaging sensor (e.g., a CMOS PCB) or other photo-detectors in the DAQ module. Alternatively, any other imaging sensor may be used with the emission module 102.

In some aspects, the emission module 102 may be designed to accept collimated/infinity space light at its base (i.e., adjacent to the tube lens 122) and focus that light to form an image at its top (e.g., adjacent to or on the output mount 600). In some non-limiting examples, the height of the emission module 102 may closely match the focal length of the tube lens 122. In some non-limiting examples, the input aperture 112 that receives incoming excitation light may be positioned a predefined distance away from the output mount 124. These predefined dimensions may allow each of the excitation module 100, the objective module 104, the emission module 102, and the DAQ module parameters to function independently from the other modules.

FIGS. 7A-7C illustrate one non-limiting example of the objective module 104. In the illustrated non-limiting example, the objective housing 126 may define a thin-walled housing that may be fabricated from metal or plastic. In some non-limiting examples, the one or more objective lenses 128 may be in the form of one or more passive optical lenses. In some non-limiting examples, the one or more objective lenses 128 may define a short focal length.

In certain aspects, the objective module 104 may act similar to a tabletop microscope's objective, however, the objective module 104 may include the focusing element 130. In some non-limiting examples, the focusing element 130 may enable non-mechanical adjustment of the focusing and/or FOV translation. In some non-limiting examples, the focusing element 130 may be an electrowetting lens that is configured to electronically adjust the focusing and/or translate the FOV. Other methods of electronic focusing are contemplated.

The combined focal length of the one or more objective lenses 128 along with the range in optical power of the focusing element 130 may define the range of working distances at which the objective module 104 can image. For example, an optical stack of two 6 mm focal length lenses along with an electrowetting lens capable of −5 to +13 diopters has a center working distance of around 800 μm and can adjust that working distance by more than +/−100 μm. By using a combination of longer focal length lenses, the working distance and adjustable range will both increase. Customization regarding the number of lenses, lens optical properties (lens type, size, focal length), and lens configuration, along with the focusing element 130, result in objective modules 104 with varying working distances, adjustable depth ranges, field-of-views, and aberration correction. Custom made, many element, miniature objective stacks may also be fabricated for specific imaging needs.

In some non-limiting examples, the focusing element 130 may have low optical power (+/−15 diopters) and may be combined with higher power optical objective lenses 128 to form the objective module 104. In this non-limiting example, the objective module 104 may have minimal aberrations, optimal working distance, and an adjustable focal range. In some non-limiting examples, the optical design of the objective module 104 may take a point source of light located below the objective module 104 (from the perspective of FIG. 7B), a distance anywhere between the objective module's 104 working distance (+/− its focal adjustment range), and collimate the light exiting the objective module's 104 back aperture (i.e., light exiting toward the emission module 102). With the back aperture of the objective module 104 being in infinity space, its optical properties may be defined independently from the rest of the system, thus enabling any emission module 102 to be mounted to any objective module 104.

FIG. 8A illustrates a schematic of an assembled microscopy assembly 106, which may be used in structured illumination and direct imaging. In the illustrated non-limiting example, the excitation module 100 may mount the excitation light source 134 at the same optical path distance (correcting for additional filter glass) away from the tube lens 122 of the emission module 102 as that of an imaging sensor 146 (e.g., a CMOS sensor, one or more photodetectors, etc.). In other words, an imaging plane 148 of the microscopy assembly 106 is the same distance away from both the excitation light source 134 and imaging sensor 146. In this way, for example, the optics of the emission module 100 and objective module 104 form an image of the surface of the excitation light source 134 co-planar to the imaging plane 148. This non-limiting configuration of the excitation module 100 may be used for structured illumination, with a DMD, SLM, fiber bundle, and/or onboard LED within the excitation module 100.

As shown by the light ray trace in FIG. 8A, excitation light may be emitted by the excitation light source 134 and then be filtered by the excitation filter 114 and shaped by the shaping element 140 (see, e.g., FIG. 8B). The filtered and shaped excitation light may produce an excitation module output that is transmitted to the emission module 102. The excitation module output may reflect off the dichroic mirror 120 and transmit through the tube lens 122, thereby focusing the excitation module output. The excitation module output that is focused by the tube lens 122 may then transmit through the focusing element 130 (e.g., an electrowetting lens) and the one or more objective lenses 128, which further focuses and directs the excitation module output toward the imaging plane 148. The combined optical effect of the tube lens 122, the focusing element 130, and the one or more objective lenses 128 on the excitation module output may act to form an image of the surface of the excitation light source 134 co-planar with the imaging plane 148.

In some non-limiting examples, the microscopy assembly 106 may also be configured to achieve wide-field fluorescence imaging used in miniature microscopes as well as single photon, tabletop fluorescence microscopes. FIGS. 8B and 8C illustrate a ray trace diagrams for an assembled microscopy assembly 106, which may be used in wide-field fluorescence imaging. With specific reference to FIG. 8B, the excitation light source 134 emits excitation light that may be filtered by the excitation filter 114 and shaped by the shaping element 140, thereby forming an excitation module output. The excitation module output is reflected by the dichroic mirror 120 and transmits through the tube lens 122, the focusing element 130, and the one or more objective lenses 128. The excitation module output that exits the objective module 104 may be near uniform excitation light that is configured to illuminate a fluorescent sample under the objective module 104.

With reference to FIG. 8C, emitted fluorescent light from the sample may travel back through the objective module 104 (i.e., transmit through the one or more objective lenses 128 and the focusing element 130), thereby forming an objective module output. The emission module 102 is configured to receive and focus the objective module output (e.g., via the tube lens 122. The objective module output may transmit through the dichroic mirror 120 and may be filtered by the emission filter 118. The objective module output may be focused onto or near that image sensor 146 to produce an emission module output that is output, for example, to a DAQ module.

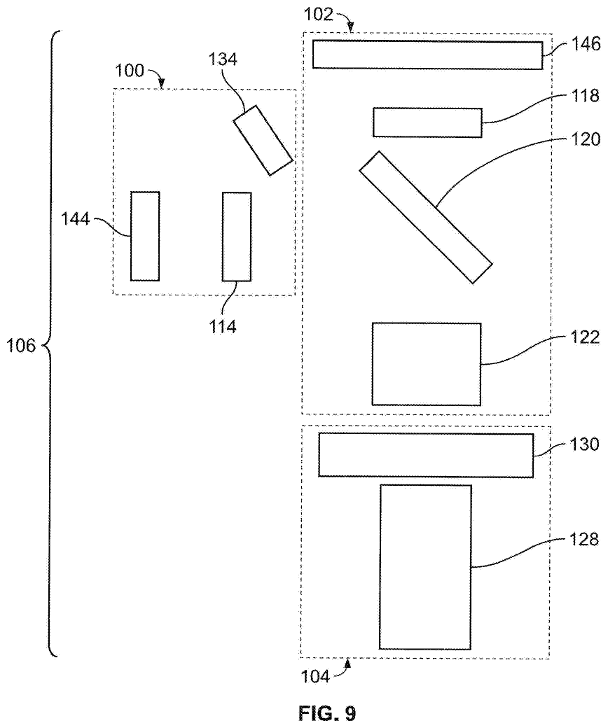

FIG. 9 illustrates another non-limiting example of an assembled microscopy assembly 106. In this non-limiting example, the excitation module 100 may be chosen such that an image of the excitation light source 134 may be formed co-planar with the imaging plane. This non-limiting configuration may also be used for structured illumination as well as a variant of wide-field imaging where imaging would benefit from excitation light having maximal power at the imaging plane 148. In the illustrated non-limiting example, the emission module 100 of FIG. 5A is used in the assembled microscopy assembly 106.

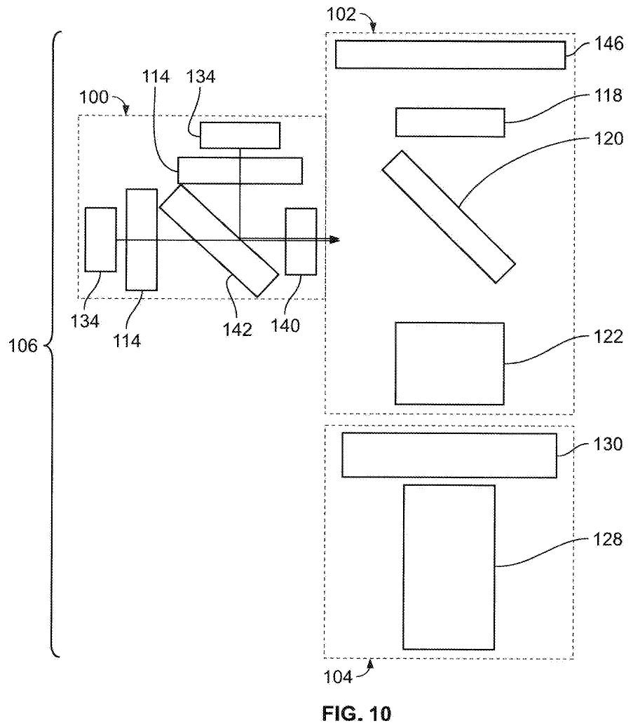

FIG. 10 illustrates another non-limiting example of an assembled microscopy assembly 106. In this non-limiting example, the excitation module 100 may include multiple excitation light sources 134. In the illustrated non-limiting example, the emission module 100 of FIG. 4 is used in the assembled microscopy assembly 106.

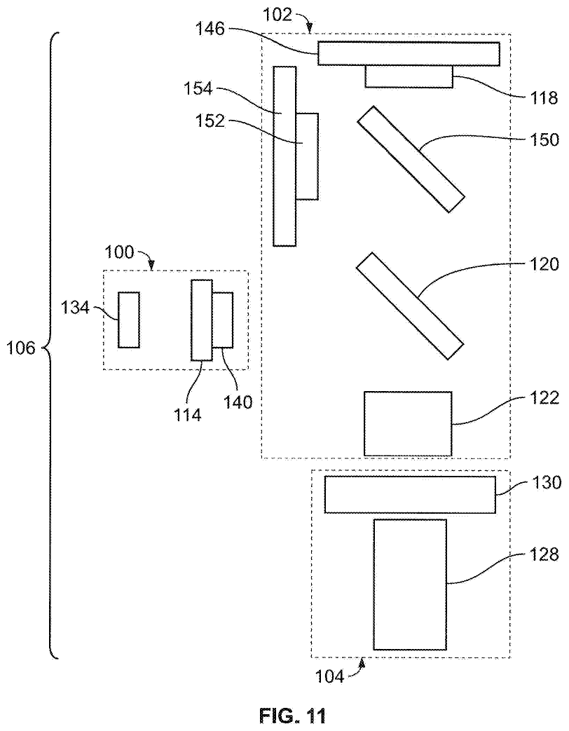

FIG. 11 illustrates another non-limiting example of an assembled microscopy assembly 106. In this non-limiting example, the microscopy assembly 106 may be configured to detect multiple wavelengths. Some fluorescence imaging/detecting applications may require detection of multiple wavelengths. While this may be achieved in an emission module 102 using, for example, an imaging sensor 146 in the form of a Bayer filter CMOS imaging sensor, some applications may require the plurality of imaging sensors 146, each detecting a different wavelength. In this regard, the emission module 102 may include an additional dichroic mirror 150, an additional emission filter 152, and an additional imaging sensor 154. In this non-limiting example, the objective module output (i.e., fluorescent light from the sample) may be transmitted through the dichroic mirror 120 to the additional dichroic mirror 150. The additional dichroic mirror 150 may be configured to reflect a portion of the objective module output within a predetermined wavelength range toward the additional emission filter 152 and the additional imaging sensor 154. A remaining portion of the objective module output may be allowed to transmit through the additional dichroic mirror 150 to the emission filter 118 and the imaging sensor 146. Thus, the imaging sensors 146 and 154 are configured to detect different portions of the objective module output wavelength spectrum, which may be determined by the optical characteristics of the additional dichroic mirror 150 and/or the emission filters 118 and 152. In the non-limiting example of FIG. 11, the optical path distance of between the excitation light source 134 and the imaging sensors 146 and 154 may remain equal, allowing for co-planar excitation/imaging.

Regardless of the specific configuration of the microscopy assembly 106, the emission module output detected by the imaging sensor 146 may be processed by a DAQ module 200. In its most basic form the DAQ module may include a power source, photo-detector, analog to digital converter (ADC), configuration/communication and data transmission channels, and interface to a computer or storage device.

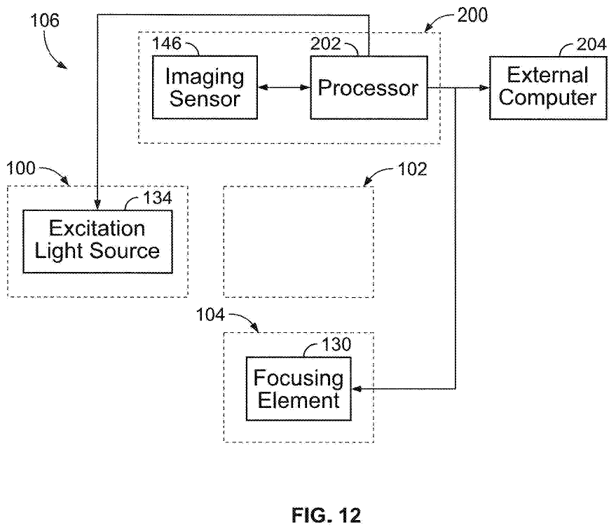

FIG. 12 illustrates one non-limiting example of the DAQ module 200 integrated into the microscopy assembly 106. As illustrated in FIG. 12, the imaging sensor 146 may be integrated into the DAQ module 200, and the DAQ module 200 may also include a processor 202. The processor 202 may be configured to digitize the emission module output detected by the imaging sensor 146 and, for example, transmit the digitized output to an external computer 204. In addition to digitizing and transmitting the emission module output, the processor 202 may be configured to control the excitation light source(s) 134 of the excitation module 100 and the focusing element 130 (e.g., an electrowetting lens) of the objective module 104. For example, the processor 202 may be configured to control an energy output, timing of emission, frequency, and wavelength of the excitation light source 134, among other things. In some non-limiting examples, the processor 202 may be configured to control or adjust a focus of the focusing element 130. In some non-limiting examples, the processor 202 may be configured to control or adjust a FOV of the microscopy assembly 106 by adjusting the focusing element 130. In some non-limiting examples, the processor 202 may also be configured to control certain parameters of the imaging sensor 146 (e.g., triggering a start of acquisition, gain, gating, exposure duration, filtering, etc.). In some non-limiting examples, the processor 202 may be in communication with a memory having instructions for driving the excitation light source 134, the imaging sensor 146, and/or the focusing element 130.

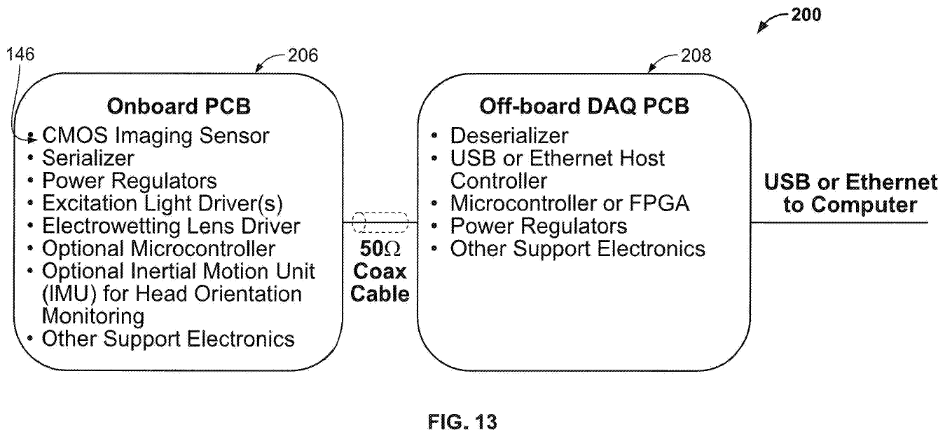

FIG. 13 shows one non-limiting example of the DAQ module 200 that may be utilized in the microscopy assembly 106. In the illustrated non-limiting example, the DAQ module 200 may include an imaging sensor 146 in the form of a CMOS imaging sensor. The DAQ module 200 may include an on-board PCB 206 that may be mounted at least partially within the output mount 124 of the emission module 102, and an off-board PCB 208 that is located remotely from the microscopy assembly 106. The off-board PCB 208 may include a deserializer, a USB or Ethernet host controller, a microcontroller or FPGA, power regulators, and support electronics. In the illustrated non-limiting example, the off-board PCB 208 may be connected to the on-board PCB via a coaxial cable. The on-board PCB 206 may include an imaging sensor 146 in the form of a CMOS imaging sensor, a serializer, power regulators, excitation light driver(s), an electrowetting lens driver, an optional microcontroller, an optional Inertial Motion Unit (IMU) for head orientation monitoring, and support electronics. The DAQ module 1200 may be connected to an external computer via USB, Ethernet, or the like.

The on-board PCB 206 may include the CMOS imaging sensor electronics/PCB, mounted to the emission module 102, connected through a thin, flexible coaxial cable to off-board readout electronics/PCB 208, which then may connect to a computer. Power, communication, and data may be all sent across the coaxial cable. These electronics may support a vast array of CMOS imaging sensors that may range in sensitivity, resolution, frame rate, and pixel size. In conjunction with the other modules, a specific DAQ module 200 with a specific imaging sensor 144 (e.g., a CMOS imaging sensor) may be picked to match each application's specific requirements (e.g., field-of-view, spatial resolution, frame rate, sensitivity). In some non-limiting examples, multiple CMOS imaging sensors may be used to image multiple wavelengths.

In some non-limiting examples, the DAQ module 200 may include an imaging sensor 146 in the form of a photo-diode. The photo-diode module may include a photo-diode with support electronics on a PCB, mounted to the emission module 102, connected to off-board readout electronics/PCB, which may connect to a computer or storage device. With an ADC on the photo-diode PCB, the DAQ module 200 and imaging sensor 146 may connect and be powered over a single coaxial cable. With ADC on the off-board readout electronics, the photo-diode PCB may connect and be powered using a 4 to 6 wire cable assembly. Multiple photo-diodes may be used to detect multiple wavelengths.

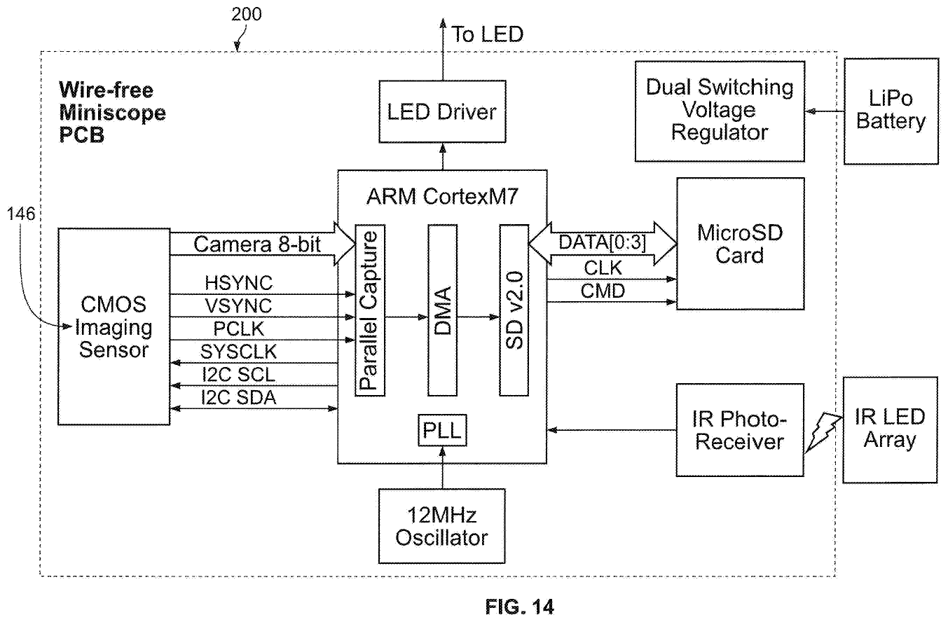

FIG. 14 illustrates another DAQ module 200 in accordance with the present disclosure. The DAQ module 200 may be configured such that all of the DAQ electronics may be placed on the microscopy assembly 106. In this configuration, the DAQ module 1200 may include an imaging sensor 146 in the form of a CMOS imaging sensor or a photo-diode, microcontroller or FPGA, storage device (e.g. a microSD card), and power source (battery or inductive/resonate charger). In certain aspects, all of the DAQ electronics may be located on a PCB that may be mounted to the emission module 102. In some aspects, it may be beneficial to mount the DAQ module PCB to at least partially in the output mount 124 of the emission module 102.

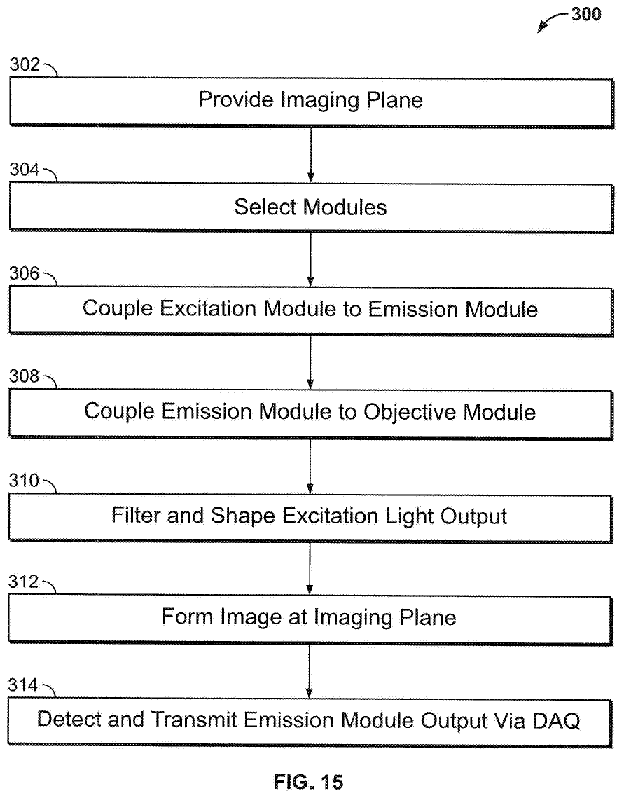

Turning to FIG. 15, the present disclosure provides a method 300 of microscope imaging. At process block 302, the method 300 may include providing a microscope imaging plane. At process block 304, the method 300 may include selecting an excitation module, an objective module, and an emission module from a set of interchangeable excitation, objective, and emission modules. At process block 306, the method 300 may include coupling the excitation module to the emission module. At process block 308, the method 300 may include coupling the emission module to the objective module. At process block 310, the method 300 may include filtering and shaping an excitation light output via the excitation module. At process block 312, the method 300 may include forming an image corresponding to the excitation light output, the image formed at the microscope imaging plane. At process block 314, the method 300 may include detecting and transmitting an emission module output via a data acquisition system.

In one non-limiting example, a microscopy assembly 106 may implement a CMOS imaging sensor as a photo-detector. In this example assembly, the resulting specifications may include: a 1 mm diameter FOV, 3× magnification, up to 1 μm spatial resolution/pixel, under 22 mm in total height, under 2 grams in mass, at least 0.8 mm working distance, and over 200 μm adjustment to working distance (imaging plane). In some non-limiting examples the microscopy assembly 106 may define a height between approximately 2 cm and approximately 6 cm. In some non-limiting examples, the microscopy assembly 106 may define a weight between approximately 1.5 grams and approximately 60 grams. As previously outlined, a user may customize assembly specifications by selecting appropriate modules (emission, excitation, objective, DAQ).

In some aspects, it may be beneficial to provide a large field-of-view configuration (FOV). To achieve a larger FOV, larger optical elements and apertures may be used. In some aspects, the FOV of the microscope may be within the range of 1 mm² to 9 mm².

In some aspects, a “fiber photometry” configuration may be implemented. In this configuration, one or more photodiodes may be used as photo-detectors in the emission module 102 and the DAQ module 1200 to detect and measure bulk fluorescence from one or multiple fluorophores. An appropriately configured excitation module 100 may be selected based upon the desired application.

In some aspects, a “fiber scope” configuration may be implemented. In this configuration, a fiber bundle may be used as the photo-detector to transmit emission light away from the microscope in order to be imaged by off-board detector(s). An appropriately configured excitation module 100 may be selected based upon the desired application.

In some aspects, a cell culture imaging array configuration may be implemented. In this configuration, an array of microscopes may be assembled to simultaneously image multiple wells or regions in cell cultures. As one non-limiting example, 96 microscopes may be assembled into a housing array under a 96 well chamber. In this configuration, imaging of each well may operate independently with its own excitation intensity, imaging gain/exposure, imaging plane, and imaging X/Y translation. Automated algorithms may be implemented to automatically configure the imaging of each well.

The present invention has been described in terms of one or more preferred aspects, and it should be appreciated that many equivalents, alternatives, variations, and modifications, aside from those expressly stated, are possible and within the scope of the invention.

For the avoidance of doubt, aspects of the present disclosure described with respect to the systems are applicable to the methods and aspects described with respect to the methods are applicable to the systems.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A microscopy system comprising:
an excitation module configured to filter and shape an excitation light and produce a corresponding excitation module output;
an objective module including at least one electrowetting lens and configured to focus and direct the excitation module output and produce a corresponding objective module output;
an electronic control configured to adjust a focus of the at least one electrowetting lens; and
an emission module coupled to the excitation module and the objective module and configured to focus the objective module output and produce a corresponding emission module output.

2. The microscopy system of claim 1, wherein the at least one electrowetting lens is configured to translate a field-of-view perpendicular to a microscope imaging plane in response to control signals from the electronic control.

3. The microscopy system of claim 1, further comprising a data acquisition module configured to digitize and transmit the emission module output to an external computer.

4. The microscopy system of claim 3, further comprising a battery configured to power the data acquisition module.

5. The microscopy system of claim 3, wherein the data acquisition module is configured to match at least one of field-of-view, spatial resolution, frame rate, and sensitivity required by the microscopy system.

6. The microscopy system of claim 1, wherein the at least one electrowetting lens has a diameter greater than 2 millimeters.

7. The microscopy system of claim 1, wherein at least one of the excitation module, objective module, or emission module is removably coupled.

8. The microscopy system of claim 1, wherein the excitation module is configured to receive a plurality of excitation light inputs forming the excitation light.

9. The microscopy system of claim 1, wherein at least one of the excitation module, objective module, or emission module are configured to be removed and replaced to adjust an imaging functionality of the microscopy system.

10. The microscopy system of claim 1, further comprising a computer system configured to store image data based of the emission module output.

11. The microscopy system of claim 1, further comprising an excitation housing for the excitation module and an emission housing for the emission module, the emission housing having a fixed attachment point for the excitation housing.

12. A microscopy system, the microscopy system comprising:
an excitation module configured to filter and shape an excitation light and produce a corresponding excitation output;
an objective module configured to focus and direct the excitation output and produce a corresponding objective output;
an emission module coupled to the excitation module and the objective module and configured to focus the objective output and produce a corresponding emission output;
a data acquisition system configured to detect the emission output; and
wherein at least one of the excitation module, objective module, emission module, and data acquisition system are configured to be disengaged from the microscopy system and replaced by replacement modules to adjust a functionality of the microscopy system.

13. The microscopy system of claim 12, wherein the excitation module comprises at least one half-ball lens.

14. The microscopy system of claim 12, wherein the microscopy system is configured to be coupled to at least one of a structured illumination system, a digital micromirror device (DMD) system, a spatial light modulator (SLM) system, or fiber bundles.

15. A method of microscope imaging, the method comprising:
providing a microscope imaging plane;
selecting an excitation module, an objective module, and an emission module from a set of interchangeable excitation, objective, and emission modules;
coupling the excitation module to the emission module;
coupling the emission module to the objective module;
filtering and shaping an excitation light output via the excitation module;
forming an image corresponding to the excitation light output, the image formed at the microscope imaging plane; and
detecting and transmitting an emission module output via a data acquisition system.

16. The method of claim 15, wherein shaping the excitation light output produces a wide-field collimated image.

17. The method of claim 15, further comprising focusing the excitation light output on or near a rear of the objective module.

18. The method of claim 15, wherein selecting the excitation module, the objective module, and the emission module is based on at least one of a working distance, a depth range, a field-of-view size, and aberration correction.

19. The method of claim 15, further comprising implementing Kohler illumination.

20. A modular microscopy system, the modular microscopy system comprising:
an excitation module configured to filter and shape an excitation light and produce a corresponding excitation module output;
an objective module configured to focus and direct the excitation module output and produce a corresponding objective module output, the objective module comprising at least one non-mechanical focusing element, the at least one non-mechanical focusing element configured for electronic focusing; and
an emission module configured to focus the objective module output and produce a corresponding emission module output, the excitation module coupled to the emission module and the emission module coupled to the objective module.

21. The microscopy system of claim 20, wherein the at least one non-mechanical focusing element is configured to translate a field-of-view perpendicular to a microscope imaging plane in response to control signals from a processor.

22. The microscopy system of claim 20, further comprising data acquisition module configured to digitize and transmit the emission module output to an external computer.

23. The microscopy system of claim 22, further comprising a battery configured to power the data acquisition system.

24. The microscopy system of claim 22, wherein the data acquisition system configured to match at least one of a field-of-view, a spatial resolution, a frame rate, and a sensitivity required by the microscopy system.

25. The microscopy system of claim 20, wherein the at least one non-mechanical focusing element has a diameter greater than 2 millimeters.

26. The microscopy system of claim 20, wherein at least one of the excitation module, objective module, or emission module is removably coupled.

27. The microscopy system of claim 20, wherein the excitation module is configured to receive a plurality of excitation light inputs forming the excitation light.

28. The microscopy system of claim 20, wherein at least one of the excitation module, objective module, or emission module are configured to be removed and replaced to adjust an imaging functionality of the microscopy system.

29. The microscopy system of claim 20, further comprising a computer system configured to store image data based on the emission module output.

30. The microscopy system of claim 20, further comprising an excitation housing for the excitation module and an emission housing for the emission module, the emission housing having a fixed attachment point for the excitation housing.
